(19) United States
(12) Patent Application Publication
(10) Pub. No.: US 2007/0039642 A1
(43) Pub. Date: Feb. 22, 2007

(54) Photovoltaic power generator

(75) Inventor: John Beavis Lasich, Deepdene (AU)

Correspondence Address: MERCHANT & GOULD PC, P.O. BOX 2903, MINNEAPOLIS, MN, 55402-0903, US

(73) Assignee: SOLAR SYSTEMS PTY LTD, VICTORIA (AU)

(21) Appl. No.: 10/557,409

(22) PCT Filed: May 19, 2004
(86) PCT No.: PCT/AU04/00668

§ 371 Date: Sep. 7, 2006

Related U.S. Application Data
(60) Provisional application No. 60/471,343, filed on May 19, 2003.

(51) Int. Cl. H02N 6/00

(52) U.S. Cl. 136/243

(57) ABSTRACT

A photovoltaic power generation system that includes a steerable light receiver with one or more photovoltaic cells for collecting light, and a supplementary light source operable to provide supplementary light under predetermined conditions. The receiver is steerable to a docking position at which the light receiver can receive light from the supplementary light source, whereby the supplementary light source can replace or augment natural light so that the power output of the system can be augmented when levels of natural or ambient light are inadequate.

### RELATED APPLICATION

This application is based on and claims the benefit of the filing date of US provisional application Ser. No. 60/471,343 filed 19 May 2003, the contents of which is incorporated herein by reference in its entirety.

### FIELD OF THE INVENTION

The present invention relates to an photovoltaic power generation method and apparatus, employing a supplementary light source so that power can be produced even when there is inadequate natural light.

### BACKGROUND OF THE INVENTION

Existing photovoltaic power generation systems that are powered by sunlight clearly only produce power when the sun is shining, and in some cases only produce adequate power output when the sunlight is above a particular intensity. This leads to intermittent power production, a degree of unpredictability in power output owing to weather variations, and less than optimal utilisation of the power generation system and the capital investment therein. The effect of these drawbacks is to increase the effective cost and reduce the availability of power from such a system.

### SUMMARY OF THE INVENTION

The present invention provides, therefore, a photovoltaic power generation system comprising:

a steerable light receiver with one or more photovoltaic cells for collecting light; and

a supplementary light source operable to provide supplementary light under predetermined conditions;

wherein said receiver is steerable to a docking position at which said light receiver can receive light from said supplementary light source, whereby said supplementary light source can replace or augment natural light so that the power output of said system can be augmented when levels of natural or ambient light are inadequate.

Thus, the power output of the system can, to some extent, be maintained even during levels of low sunlight (such as under cloudy conditions, dusk, night, etc.). The system uses its own light receiver as the light receiver for receiving light from the supplementary light source.

The receiver will typically comprise an array of photovoltaic cells.

The supplementary light source can be powered by any suitable means and fuel, but preferably the supplementary light source is fuelled by gas (such as methane, ethane or liquid petroleum gas), by an oil or petroleum fraction (such as petrol, gasoline or diesel oil), alcohol, or mixture of any of these.

Preferably said system is a solar power generation system and said supplementary light source is located within the sweep of said steerable light receiver, wherein said docking position is not normally traversed during solar tracking.

Preferably the system includes an energy storage to further sustain the power output of said system. The energy storage can comprise—for example—a fly wheel, a battery, a capacitor, or a bank of any one or more of these.

Preferably the supplementary light source emits or is operable to omit light at a frequency or spectrum of frequencies selected to maximise power generated from light provided by said supplementary light source. Thus, it is envisaged that the supplementary light source would operate at a temperature of at least 1000° C., but this can be tuned according to the characteristics of the system to optimise either efficiency or output, or some desired balance of both.

Preferably the system includes a light concentrator (such as a focusing spherical or parabolic dish) for concentrating incident light onto said photovoltaic cell or cells.

Thus, the system itself preferably includes a spherical or parabolic mirrored dish for focusing incident (generally solar) light onto the photovoltaic cell or cells. In may be desired, in some embodiments, to locate the supplementary light source so that light emitted by the supplementary light source is collected by the light concentrator and then concentrated onto the light receiver.

Preferably said supplementary light source is located so that said light receiver can be positioned to collect a high proportion of light emitted directly by said supplementary light source.

In one embodiment said supplementary light source is moveable so as not to block natural or ambient light from impinging said receiver.

In one embodiment, the system includes a plurality of such light sources, each operable to illuminate said photovoltaic cells under predetermined conditions.

The present invention also provides a method of generating power by means of a solar powered photovoltaic power generator with a steerable light receiver, the method comprising:

providing artificial light under predetermined conditions by means of a supplementary light source to replace or supplement natural or ambient light;

arranging said supplementary light source relative to said light receiver so that said light receiver can be steered to collect light from said light source under said predetermined conditions;

whereby said supplementary light source can be switched on to replace or augment natural light so that the power output of said power generator can be augmented when levels of natural or ambient light are inadequate.

Preferably the method includes fuelling the supplementary light source with gas, an oil or petroleum fraction, alcohol, or mixture of any of these.

The method may include sustaining power output (such as during the transition from solar to supplementary light) by means of an energy storage means, which can comprise—for example—a fly wheel, a battery, a capacitor, hydrogen storage, or a bank of any one or more of these.

Preferably the method includes concentrating said artificial light by means of a light concentrator (such as a focusing spherical or parabolic dish) for concentrating incident light onto said photovoltaic cell or cells, whereby said light receiver collects light from said light source via said concentrator.

Thus, the artificial light could be concentrated by means of the concentrator before being directed onto the receiver.

Preferably the supplementary light source emits light at a frequency or spectrum of frequencies selected to maximise power generated from said supplementary light source by said power generator.

In this embodiment, a selective emitter can be used; the light and heat from burning fuel heats the selective emitter (the supplementary light source in this case) to a temperature where it will emit at a frequency optimized for the photovoltaic cells.

Preferably the method includes locating said supplementary light source so that said light receiver can be positioned to collect a high proportion of light emitted directly by said supplementary light source.

In one embodiment, the method includes providing a plurality of such light sources, each operable to provide light collectable by said light collector under respective predetermined conditions.

### BRIEF DESCRIPTION OF THE DRAWING

In order that the present invention may be more clearly ascertained, an embodiment will now be described, by way of example, with reference to the accompanying drawing in which:

FIG. 1 is a view of a photovoltaic power generator according to an embodiment of the present invention when the generator's supplementary light source is not required; and

FIG. 2 is a view of a photovoltaic power generator of FIG. 1 when the generator's supplementary light source is in use.

### DETAILED DESCRIPTION

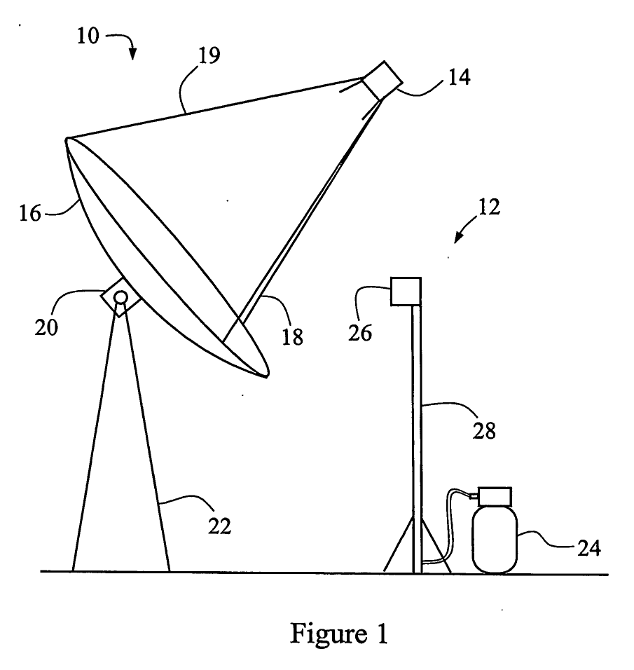

A photovoltaic power generator according to an embodiment of the present invention is shown in FIG. 1.

The generator includes a dish concentrator photovoltaic system 10 and a supplementary light source in the form of artificial lighting system 12.

The photovoltaic system 10 includes a light receiver in the form of a light receiver 14, which includes an array of photovoltaic cells (not shown). The light receiver 14 is located at the focus of dish concentrator 16, and supported on concentrator 16 by means of support arms 18. Both light receiver 14 and concentrator 16 are ultimately supported by housing 20 which contains a drive (not shown) which in normal operation steers the concentrator 16 and maintains its orientation towards the sun. The drive is controlled by any suitable means, typically by determining the position of the sun (by calculation, from look-up tables periodically, sunlight detection, or a combination of these), and directing the concentrator 16 accordingly.

The above mentioned components of the photovoltaic system 10 are supported by a mount 22.

Artificial lighting system 12 includes one or more gas storage cylinders 24 (unless a suitable mains gas or other energy supply is available, in which case this can replace the cylinder or cylinders 24). The gas can be any suitable gas, such as methane, ethane or liquid petroleum gas. The gas is burnt in a burner 26 supported by a stand 28, so that burner 26 is at substantially the same height as light receiver 14. The artificial lighting system 12 is located so that it does not cast a shadow onto concentrator 16 when there is sufficient sunlight.

The artificial lighting system 12 and its gas supply are chosen to emit light in a spectrum of frequencies selected to maximise power ultimately generated from light from the artificial lighting system 12. Thus, it is envisaged that the burner 26 would operate at a temperature of at least 1000° C.

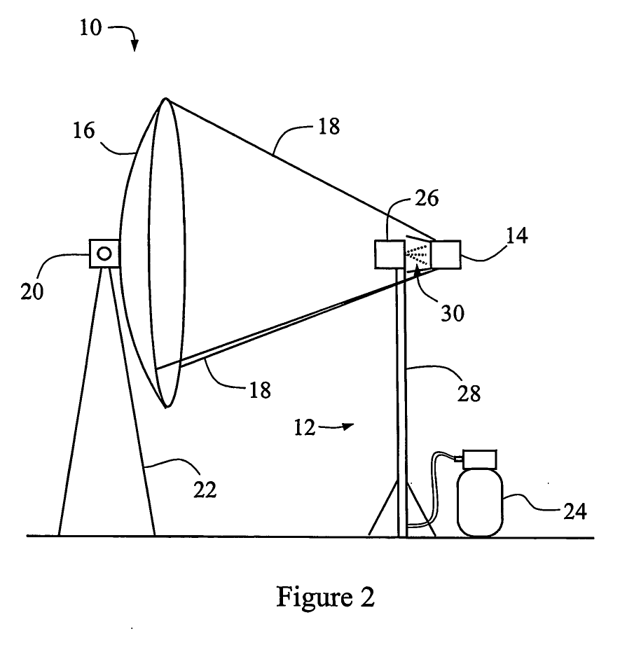

Referring to FIG. 2, when inadequate solar radiation is available, the concentrator 16 and hence light receiver 14 are rotated to the docking position shown in FIG. 2, in which the concentrator 16 is facing essentially horizontally towards the rear of burner 26, and the light receiver 14 is located facing the front or light emitting side of burner 26. Consequently, the burner 26 is between the concentrator 16 and the light receiver 14. This docking position (shown in FIG. 2) is within the sweep of the concentrator 16 and light receiver 14, but in a zone not normally traversed by the system 10 during solar tracking.

The artificial lighting system 12 is switched on (manually or automatically) by providing a flow of gas to burner 26 and igniting that gas; light 30 emitted by burner 26 is directed towards light receiver 14, so that power can continue to be generated by the photovoltaic system 10.

The artificial lighting system 12 can optionally include optics (either imaging or non-imaging) to optimize and concentrate the selectively emitted light from the fuel burner 26 to the light receiver 14.

Also, the system 10 can be configured to steer the concentrator 16 to the docking position shown in FIG. 2 in two preferred ways. Firstly, the detection of inadequate natural light and the consequent switching on of the artificial lighting system 12 can also be used to prompt the drive of system 10 to steer the concentrator 16 and receiver 14 to the docking position. Alternatively, the photovoltaic system 10 is preferably provided with light sensors to assist in maintaining its orientation towards the sun; these sensors and their control system can be tuned to interpret light 30 from burner 26 as the “sun”, and to steer the concentrator 16 and receiver 14 to the docking position once burner 26 becomes the strongest light source in the vicinity, that is, when sunlight drops to an inadequate level and the burner 26 is switched on.

The generator of this embodiment is also provided with an energy buffer to reduce power fluctuations, such as when switching between the use of sunlight and artificial light or to reduce variations in power output caused by variations in sunlight, or to reduce the difference between power output due to sunlight alone and due to artificial light alone. This would take the form of one or more flywheels, batteries or super capacitors (not shown), which—like the artificial lighting system—are switched into or out of the system according to measured light and/or power output levels.

This concept of the present invention can also be used with a central receiver system where, in existing systems, a plurality of separately controlled mirrors in a heliostat field are used to focus sunlight to one or more fixed or moving photovoltaic receivers in order to produce electricity from that sunlight. In such an application, the artificial lighting system would be positioned in essentially a similar manner to the above-described dish concentrator embodiment, ensuring that light from the artificial lighting system can reach the receiver but without obstructing sunlight reflected from the heliostat mirrors during normal operation. To achieve this it may be necessary to provide a moveable artificial lighting system that can be moved out of the path of light reflected from the heliostat field to the receiver.

Modifications within the scope of the invention may readily be effected by those skilled in the art. It is to be understood, therefore, that this invention is not limited to the particular embodiments described by way of example here and above.

In the claims that follow and in the preceding description of the invention, except where the context requires otherwise owing to express language or necessary implication, the word “comprise” or variations such as “comprises” or “comprising” is used in an inclusive sense, i.e. to specify the presence of the stated features but not to preclude the presence or addition of further features in various embodiments of the invention.

Further, any reference herein to prior art is not intended to imply that such prior art forms or formed a part of the common general knowledge.

1. A photovoltaic power generation system comprising:
a steerable light receiver with one or more photovoltaic cells for collecting light; and
a supplementary light source operable to provide supplementary light under predetermined conditions;
wherein said receiver is steerable to a docking position at which said light receiver can receive light from said supplementary light source, whereby said supplementary light source can replace or augment natural light so that the power output of said system can be augmented when levels of natural or ambient light are inadequate.

2. A system as claimed in claim 1, wherein said receiver comprises an array of photovoltaic cells.

3. A system as claimed in claim 1, wherein said supplementary light source is fuelled by gas, an oil or petroleum fraction, alcohol, or mixture of any of these.

4. A system as claimed in claim 1, wherein said system is a solar power generation system and said supplementary light source is located within the sweep of said steerable light receiver, wherein said docking position is not normally traversed during solar tracking.

5. A system as claimed in claim 1, wherein said system includes an energy storage to further sustain the power output of said system.

6. A system as claimed in claim 1, wherein said supplementary light source emits or is operable to omit light at a frequency or spectrum of frequencies selected to maximise power generated from light provided by said supplementary light source.

7. A system as claimed in claim 6, wherein said supplementary light source operates at a temperature of at least 1000° C.

8. A system as claimed in claim 1, further comprising a light concentrator for concentrating incident light onto said photovoltaic cell or cells.

9. A system as claimed in claim 8, wherein said light concentrator comprises a focusing spherical or parabolic dish.

10. A system as claimed in claim 8, wherein said supplementary light source is located so that light emitted by said supplementary light source can be collected by said light concentrator and then concentrated onto said light receiver.

11. A system as claimed in claim 1, wherein said supplementary light source is located so that said light receiver can be positioned to collect a high proportion of light emitted directly by said supplementary light source.

12. A system as claimed in claim 1, wherein said supplementary light source is moveable so as not to block natural or ambient light from impinging said receiver.

13. A system as claimed in claim 1, further comprising a plurality of such light sources, each operable to illuminate said photovoltaic cells under predetermined conditions.

14. A method of generating power by means of a solar powered photovoltaic power generator with a steerable light receiver, the method comprising:
providing artificial light under predetermined conditions by means of a supplementary light source to replace or supplement natural or ambient light;
arranging said supplementary light source relative to said light receiver so that said light receiver can be steered to collect light from said light source under said predetermined conditions;
whereby said supplementary light source can be switched on to replace or augment natural light so that the power output of said power generator can be augmented when levels of natural or ambient light are inadequate.

15. A method as claimed in claim 14, including fuelling said supplementary light source with gas, an oil or petroleum fraction, alcohol, or mixture of any of these.

16. A method as claimed in claim 14, including sustaining power output by means of an energy storage.

17. A method as claimed in claim 14, including concentrating said artificial light by means of a light concentrator for concentrating incident light onto said photovoltaic cell or cells, whereby said light receiver can collect light from said light source via said concentrator.

18. A method as claimed in claim 14, wherein said supplementary light source emits light at a frequency or spectrum of frequencies selected to maximise power generated from said supplementary light source by said system.

19. A method as claimed in claim 14, including providing said supplementary light source in the form of a selective emitter.

20. A method as claimed in claim 14, including locating locating said supplementary light source so that said light receiver can be positioned to collect a high proportion of light emitted directly by said supplementary light source.

21. A method as claimed in claim 14, including providing a plurality of such light sources, each operable to provide light collectable by said light collector under respective predetermined conditions.
